(19) United States
(12) Patent Application Publication
(10) Pub. No.: US 2024/0007479 A1
(43) Pub. Date: Jan. 4, 2024

(54) METHOD AND APPARATUS FOR DECENTRALIZED MANAGEMENT OF TRUSTED DATA ON TRUSTLESS NETWORKS

(71) Applicant: Securrency, Inc., Annapolis, MD (US)

(72) Inventor: George Daniel Doney, Riva, MD (US)

(73) Assignee: Securrency, Inc., Annapolis, MD (US)

(21) Appl. No.: 18/469,236

(22) Filed: Sep. 18, 2023

Related U.S. Application Data
(63) Continuation-in-part of application No. 17/677,657, filed on Feb. 22, 2022.
(60) Provisional application No. 63/151,840, filed on Feb. 22, 2021.

(51) Int. Cl. H04L 9/40

(52) U.S. Cl. CPC H04L 63/12

(57) ABSTRACT

A framework for managing data on a decentralized network is disclosed. The framework is designed to manage two conflicting forces, openness and control, in order to provide scalable trust on trustless networks. To manage this conflict, a flexible, decentralized governance model is disclosed to enable any DLT user to create and manage data contexts, a virtual boundary for controlling data rights, meaning, and value so as to produce accountable, trusted data with full provenance. The framework does not need to determine who should be trusted, how the trust network forms, or how meaning is developed while providing a governance model by which any authorized user can contribute meaning (properties) and monetize attributable data (attestations).

### CROSS REFERENCES TO RELATED APPLICATIONS

This application is related to and claims priority from the following U.S. patent applications. This application is a continuation-in-part of U.S. application Ser. No. 17/677,657, filed Feb. 22, 2022, which claims priority to and the benefit of U.S. Provisional Patent Application No. 63/151,840, filed Feb. 22, 2021, each of which is incorporated herein by reference in its entirety.

### BACKGROUND OF THE INVENTION

### 1. Field of the Invention

The present invention relates to decentralized asset management systems, and more specifically to systems for creation of assets on a decentralized management system.

### 2. Description of the Prior Art

It is generally known in the prior art to provide platforms for decentralized asset management and data transfer.

Prior art patent documents include the following:

US Patent Publication No. 2022/0051261 for Processes and systems of blockchain with verification through a consortium of stakeholders by inventor Vetas, filed May 29, 2021, and published Feb. 17, 2022, is directed to a management system having a blockchain structure. The system includes a consortium of stakeholder computers connected to a platform. The consortium of stakeholders providing user inputted data associated with product providence. The platform is integrated with a blockchain database to verify and manage user inputted data. The platform is configured to validate and assign values to the user inputted data to connect to related data within the blockchain database. A user interface is configured to display qualified data based on user search queries and focus search results to provide a roadmap of the data relevant to a particular product or value.

US Patent Publication No. 2021/0377263 for Distributed computing systems for strong user authentication and related methods by inventor Law, filed Apr. 22, 2021, and published Dec. 2, 2021, is directed to a distributed computing system is used to form a login network to verify the identity of users. The login network uses biometric authentication on a user device to digitally sign a payload, which is sent to the login network for verification. The login network executes the verification using blockchain computing architecture, which is decentralized. The login network provides strong customer authentication, decentralization of data and authentication, a trusted identity service, and privacy and control of the user data by the user.

U.S. Pat. No. 11,250,466 for Systems and methods for using secured representations of user, asset, and location distributed ledger addresses to prove user custody of assets at a location and time by inventor Soundararajan, filed Jul. 30, 2018, and issued Feb. 15, 2022, is directed to systems and methods for using a distributed ledger network and devices that transmit secured representations of distributed ledger addresses to prove the custody of an asset by a user at a particular location and time. In some implementations, a method includes: transmitting to a server system operating as a node on a distributed ledger network: a first secured representation of a distributed ledger address associated with a first location; a second secured representation of a distributed ledger address associated with an asset; and a third secured representation of a distributed ledger address associated with a user; and receiving a confirmation message from the server system.

U.S. Pat. No. 11,250,423 for Encapsulated security tokens for electronic transactions by inventor Heyner, filed Aug. 22, 2019, and issued Feb. 15, 2022, is directed to functional data for use in one or more digital transactions secured by using an encapsulated security token (EST). In certain embodiments, the EST is created by encapsulating digital data including the functional data using at least two cryptographic systems of two parties. The encapsulation and subsequent de-encapsulation can utilize cryptographic systems of the parties that involve a private key for signing and decryption and a public key for encryption and signature verification. If constructed carefully over a series of rigorous events, the resulting EST can be practically impossible to counterfeit. In addition, a propagation of rights can be tracked for auditing and rights can be easily terminated or modified.

U.S. Pat. No. 11,159,307 for Ad-hoc trusted groups on a blockchain by inventor Bathen, filed Aug. 8, 2018, and issued Oct. 26, 2021, is directed to an example operation may include one or more of identifying a group of blockchain member devices attempting to establish a trusted group communication channel, assigning each of the blockchain member devices public/private key pairs, publishing the public keys of the blockchain member devices in a list, identifying a request from a first blockchain member device requesting a private key, associated with a second blockchain member device, be applied to a predetermined nonce value, responsive to identifying a response to the request, verifying, via a public key assigned to the first blockchain member device, that the second blockchain member device is a trusted member of the group of blockchain member devices, and responsive to verifying the second blockchain member device is a trusted member of the group of blockchain member devices, permitting communication between the first blockchain member device and the second blockchain member device on the trusted group communication channel.

U.S. Pat. No. 10,735,202 for Anonymous consent and data sharing on a blockchain by inventor Jayachandran, filed Jul. 24, 2017, and issued Aug. 4, 2020, is directed to an example operation may include one or more of storing a user profile in a blockchain by an authorized member of the blockchain, receiving a request by another authorized member of the blockchain to access the user profile, identifying the request for the user profile is from the another authorized member of the blockchain, creating a signed message that includes consent to share the user profile with the another authorized member of the blockchain, and transmitting the signed message to the another authorized member of the blockchain, and wherein an exchange of the user profile between the blockchain members is performed without revealing blockchain member identities of the authorized member of the blockchain and the another authorized member of the blockchain to any of the blockchain members.

U.S. Pat. No. 10,673,626 for Threshold secret share authentication proof and secure blockchain voting with hardware security modules by inventor Sandberg-Maitland, filed Dec. 31, 2018, and issued Jun. 2, 2020, is directed to an encryption-protected decentralized and replicated blockchain file storage system maintained and managed by a channel of peers, the invention creates the additional levels of trust that are needed for peer voter authentication and transaction proposal endorsement. The invention effectively excludes hostile agents from influencing or impersonating legitimate voter peers through the mathematical strength of the K-of-N mechanism based on secret sharing with cryptographic hashing. In a further embodiment an extension to nested signatures is disclosed to enforce signing order.

U.S. Pat. No. 10,489,597 for Blockchain verification of network security service by inventor Safford, filed Mar. 28, 2017, and issued Nov. 26, 2019, is directed to a system may include a communication port to exchange information with a client device associated with an industrial control system. A network security server coupled to the communication port may include a computer processor adapted to provide a network security service for the client device. The computer processor may further be adapted to record security information about the client device via a blockchain verification process (e.g., by registering a validation result within a distributed ledger). The network security service might comprise, for example, an integrity attestation service providing software verification for the client device.

### SUMMARY OF THE INVENTION

The present invention relates to decentralized computer platforms for storing and managing information relating to digital assets on a distributed ledger. The computer platform includes an attestation registry accessible via the computer platform, wherein the attestation registry accesses additional data schema to evaluate data and attest to a characteristic or behavior of the digital asset.

It is an object of this invention to provide a smart-contract-based, general purpose data management layer with flexible controls to enable a decentralized coalition of participants to define data schema, share data, track provenance and data staleness, mediate between differing formats for data consumption, and manage access and authority to create, update, and delete decentralized data.

In one embodiment, the present invention includes a method of managing trusted data on a decentralized network, comprising creating a property registry on a computer platform, wherein the computer platform is implemented on a distributed ledger, the property registry storing at least one data definition, wherein a property including a name, a data type, and a source is defined by the at least one data definition, wherein the property is stored in the property registry, a source registry executing a smart contract to access the property stored in the property registry, adding the property to the source registry, the source registry deploying a smart contract assigning authorization to a smart contract address to enable the smart contract address to access, edit, and/or delete the property, the source registry executing a smart contract for verifying authorization to access, edit, and/or delete the property, and assigning at least one value to the property and storing the at least one value in a memory of a value registry.

In another embodiment, the present invention includes a system for management of data on a decentralized network, comprising a decentralized computer platform including a processor and a memory, wherein the decentralized computer platform accesses a distributed ledger, wherein the decentralized computer platform includes an attestation registry comprising a property registry, a source registry, a value registry, an option registry, and a unit conversion registry, wherein the property registry defines at least one property including a name, data, a data type, and a source, wherein the at least one property is stored in the property registry, wherein the source registry governs access to the property stored in the property registry by deploying a smart contract for verifying authorization to access, edit, and/or delete the property, wherein the value registry includes at least one value associated with the property, wherein the options registry stores a list of constraint options, wherein the constraint options are enumerations of the at least one value stored in the value registry, and wherein the unit conversion registry includes a list of one or more smart contracts for converting the data from a first unit format into a second unit format.

In yet another embodiment, the present invention includes a method of managing trusted data on a decentralized network, comprising creating a property registry on a computer platform, wherein the computer platform is implemented on a distributed ledger, the property registry storing at least one data definition, wherein a property including a name, data, a data type, and a source is defined by the at least one data definition, wherein the property is stored in the property registry, the property registry using a primary key of the property registry to indicate the location of the name, the data type, and the source within the property registry, a source registry executing a smart contract to access the property stored in the property registry, wherein the source registry uses a foreign key of the source registry to access the property, wherein the foreign key of the source registry indicates the location of the name, the data type, and the source within the property registry, adding the property to the source registry, the source registry deploying a smart contract assigning authorization to a smart contract address to enable the smart contract address to access, edit, and/or delete the property, the source registry executing a smart contract for verifying authorization to access, edit, and/or delete the property, assigning at least two values to the property and storing the at least two values in a memory of a value registry; and an options list registry executing a smart contract for enumerating at least one combination of the at least two values stored in the value registry, wherein the enumeration is stored in the options list registry.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic diagram of a computing architecture according to one embodiment of the present invention.

FIG. 2 is a schematic illustration of a data schema for effecting the Attestation Registry according to one embodiment of the present invention.

FIG. 3 is a flowchart of a process for entering data control information according to one embodiment of the present invention.

FIG. 4 is a flowchart of a process for assigning assets to a source according to one embodiment of the present invention.

FIG. 5 is a schematic diagram of a system of the present invention.

### DETAILED DESCRIPTION

The present invention is generally directed to computer platforms including a smart-contract-based, general purpose data management layer for storing and managing information relating to digital assets on a distributed ledger.

In one embodiment, the present invention includes a method of managing trusted data on a decentralized network, comprising creating a property registry on a computer platform, wherein the computer platform is implemented on a distributed ledger, the property registry storing at least one data definition, wherein a property including a name, a data type, and a source is defined by the at least one data definition, wherein the property is stored in the property registry, a source registry executing a smart contract to access the property stored in the property registry, adding the property to the source registry, the source registry deploying a smart contract assigning authorization to a smart contract address to enable the smart contract address to access, edit, and/or delete the property, the source registry executing a smart contract for verifying authorization to access, edit, and/or delete the property, and assigning at least one value to the property and storing the at least one value in a memory of a value registry.

In another embodiment, the present invention includes a system for management of data on a decentralized network, comprising a decentralized computer platform including a processor and a memory, wherein the decentralized computer platform accesses a distributed ledger, wherein the decentralized computer platform includes an attestation registry comprising a property registry, a source registry, a value registry, an option registry, and a unit conversion registry, wherein the property registry defines at least one property including a name, data, a data type, and a source, wherein the at least one property is stored in the property registry, wherein the source registry governs access to the property stored in the property registry by deploying a smart contract for verifying authorization to access, edit, and/or delete the property, wherein the value registry includes at least one value associated with the property, wherein the options registry stores a list of constraint options, wherein the constraint options are enumerations of the at least one value stored in the value registry, and wherein the unit conversion registry includes a list of one or more smart contracts for converting the data from a first unit format into a second unit format.

In yet another embodiment, the present invention includes a method of managing trusted data on a decentralized network, comprising creating a property registry on a computer platform, wherein the computer platform is implemented on a distributed ledger, the property registry storing at least one data definition, wherein a property including a name, data, a data type, and a source is defined by the at least one data definition, wherein the property is stored in the property registry, the property registry using a primary key of the property registry to indicate the location of the name, the data type, and the source within the property registry, a source registry executing a smart contract to access the property stored in the property registry, wherein the source registry uses a foreign key of the source registry to access the property, wherein the foreign key of the source registry indicates the location of the name, the data type, and the source within the property registry, adding the property to the source registry, the source registry deploying a smart contract assigning authorization to a smart contract address to enable the smart contract address to access, edit, and/or delete the property, the source registry executing a smart contract for verifying authorization to access, edit, and/or delete the property, assigning at least two values to the property and storing the at least two values in a memory of a value registry; and an options list registry executing a smart contract for enumerating at least one combination of the at least two values stored in the value registry, wherein the enumeration is stored in the options list registry.

In a further embodiment, the present invention includes a method for creating a trusted data management model in a decentralized computing environment and a distributed computing system for accomplishing the method, the method including creating infrastructure, by the deployment of smart contracts to a distributed ledger, the infrastructure including a data structure for capturing, indexing, and storing attestation data corresponding to an attestation, wherein an attestation is a claim about an item or a linkage between items made by at least one authorized and accountable attesting user in a data context; creating and managing a source in a source registry smart contract, by an authorized data management user signing a distributed ledger transaction, a source specifying a control context for the management of data, the data including attestation data and properties which define the attestation data, the control context defining a governance model to be applied to the corresponding data, whereby the authorized data management user can at least one of define, delegate, and/or decentralize rights to manage the data in the context, the rights being the ability for data consumption users to read or write data assigned to the control context using a distributed ledger public/private key; assigning at least one property to corresponding attestation data, by an authorized property assignment user, by signing a distributed ledger transaction, each of said at least one property including a source, a name, a data type, at least one value constraint, a unit designation, and structure to the corresponding attestation data to thereby define the attestation data; making at least one attestation, by an attestor who is one of the at least one authorized and accountable attesting users, by submitting attestation data and signing a distributed ledger transaction, the attestation data pertaining to an item or a linkage between items, wherein the item is keyed by a unique identifier of an object corresponding to the item, wherein the attestation data is assigned to at least one corresponding property defining the attestation data, the attestation data preserving an identity of the attestor, the attestation data containing a last update date and an expiration date; and consuming attestation data, by a third party smart contract or an authorized consuming user signing a distributed ledger transaction.

None of the prior art discloses the use of a source registry, property registry, and options value registry, wherein the registries include a primary key pointing to data within the registry and a foreign key used to point to information located in an adjacent registry. Further, none of the prior art discloses a unit conversion registry to convert data from a first unit format to a second unit format within the distributed ledger.

Distributed ledger technology (DLT) is a decentralized, immutable computer ledger that enables the creation of digital assets. The digitization of assets is advantageous in removing the participation of intermediaries that are typically necessitated in physical issue and transaction of assets. A distributed ledger is a type of distributed database that operates without a central authority and replicates an identical copy to a non-hierarchical network of nodes that communicate with each other over peer-to-peer protocols. The ledger and resulting state of the system is secured from fault through the use of consensus mechanisms that replace the trusted node or central authority used in traditional distributed databases. These consensus mechanisms ensure agreement on an asset during management and transfer of the asset, thereby establishing a data consensus and preventing fault errors.

Distributed ledgers have previously been used to create and manage digital currency, but recent systems have been developed to create digital representations, known as tokens, of both fungible (e.g., currency, gold, oil) and non-fungible assets (e.g., share certificates, crypto art). These tokens are created and transacted on DLT platforms. An advantage of these systems is that the digital assets are operable to be exchanged simultaneously (e.g., asset-for-currency exchange or currency-for-currency exchange) using standardized logic without the need for reconciliation or a central authority. Another advantage inherent in DLT is the ability to decentralize state change authorization decisions. As DLT has evolved, the distributed ledger serves as the foundation for a decentralized computing platform that provides an environment for the execution of programs stored on the ledger.

The various functions of DLT systems are executed by smart contracts, which are executable code stored on a distributed ledger, thereby enabling versatility in DLT systems. However, as the range of applications for DLT has expanded, it has become difficult to manage rights in the various transactions accomplished on the ledger. For example, transactions of financial instruments are highly regulated by various authorities to protect market participants and thereby require a framework of data rights management.

Some prior art systems utilize third-party services, known as oracles, that share data from the off-chain to the smart contracts stored on the DLT (i.e., on-chain). The oracle verifies and authenticates data through trusted Application Programming Interfaces (API). Smart contracts then utilize the information to make decisions. However, the use of oracles alone has not significantly decentralized the creation and sharing of data on-chain, especially the creation and transfer of individual data elements or attestations shared between untrusted smart contracts or assigned by individual or collective end-users.

The computer platform of the present invention advantageously enables the decentralization of data sharing on a distributed ledger. The immutable nature of distributed ledger technologies enables immutable certification of assets on the ledger. Thus, the present invention enables participants to attest (i.e., to post data with attribution about an object of interest) where data is a value with meaning. An attestation process includes assigning a statement in an understandable format about a characteristic of a thing or things by a qualified party for a period of time for which the statement is valid in a context (i.e., the source) where the authority and meaning of the statement are identifiable. This is accomplished by assigning a value in an understandable data type about a property of an identified object or objects within the system of the present invention.

The present invention provides methods and systems to create a decentralized ecosystem of data producers, such as attestations agents, and data consumers on distributed ledger networks. The attestation registry disclosed herein provides a smart-contract-based, general purpose data management layer with flexible controls to enable a decentralized coalition of participants to define data schema, share data, track provenance and data staleness, mediate between differing formats for data consumption, and manage access and authority to create, update, and delete decentralized data.

The smart contract of the attestation registry, referred to herein as AttestationRegistry, consists of three main parts: a property registry to manage data definitions; a source registry to manage data rights (e.g., editing rights); and a registry for assigning property values to objects while storing attribution and expiration.

The present invention includes a series of linked registries to create objects of physical assets on the distributed ledger and manage the principal objects that enable data configuration and data rights management. A distributed ledger registry includes a smart contract that contains a table defining the structure of the principal object of the registry with each row being a unique instance of the object. For example, the smart contract of the source registry, referred to herein as SourceRegistry, contains a table and related data structures with each row representing a registered data source. The source registry's smart contract contains logic to create, update, delete, and manage a source of data.

The present invention provides an open, flexible model for creating data contexts (i.e., the network of connections between data points) in order to create the conditions for reliable, trusted data on trustless distributed ledger networks. The openness and immutability of distributed ledger networks provides a powerful substrate for data management. However, innovations are required to enable trustless distributed ledgers to support the data management practices required for trusted data. The present invention includes a framework designed to manage two conflicting concepts, openness and control, in order to provide scalable trust. To manage this conflict, a data context, recorded as a source in a source registry, establishes a virtual boundary for controlling data rights, meaning, and value so as to produce accountable, trusted data with full provenance for authorized participants in the data context. The model is designed to be open and decentralized, making no judgment on who should be trusted, how the trust network forms, or how meaning is developed, but rather providing the means for authorized parties to establish a data context, and manage it to maintain the trust desired by the context.

The present invention provides a flexible governance model to decentralize data management by creating an open, accessible, accountable, general-purpose trusted data storage framework on a trustless distributed ledger by which any authorized user contributes meaning and attributable data to the network in the form of input properties and attestations. Creation of an attestation includes assigning a statement in an understandable format about a characteristic of a thing or things by a qualified party for a period of time for which the statement is valid in a context where the authority and meaning of the statement are identifiable. This is accomplished by assigning a value in an understandable data type to a property of an identified object or objects within the system of the present invention.

For example, a financial institution attests to the Know Your Customer (KYC) status of a party by assigning the Boolean value “true” to the property KYC. The status having been verified, the property is assigned to the wallet of the party, attributable to the financial institution which verified the status, and valid for a specified or unspecified length of time. In another example, a rating agency assigns a rating “AAA” to a bond for a financial quarter. In a third example, the asset manager may assign the Net Asset Value (NAV) of $40/share to a fund for the day.

In one embodiment, a source (i.e., a data context) is established by any authorized participant via a blockchain wallet, that is a public/private key pair with the means to affect a state change on the distributed ledger. The source creator has the means to define the control model for any data within the context including the ability to delegate control to other participants as required to scale the data and trust required by the context. Open data contexts are created through the use of a source registry to permit any authorized user with a blockchain address to create a data context, define properties (i.e., an informal data schema), and control, delegate, write, and read the data. Source control types include creator controlled, roles-based access control (RBAC), and attribute-based access control (ABAC) through the use of configurable policies.

The first step in developing a trusted data context is to develop semantics, that is the meaning of data assigned to objects in the network, in the disclosed implementation meaning is maintained by end-user configurable properties. The authority to assign meaning is as important as the data itself, therefore the generation of properties must be both flexible and controllable. The disclosure enables authorized users to define properties, as described below. A property is a characteristic assigned to an object thereby defining the object itself. Properties have a name, a data type, source that defines the right of the property to define and establish values associated with a property), and other parameters used to establish meaning.

In their simplest form, a property is like a column in a data table, such as price, where each object (row in the table) is assigned a decimal value. This structure, while common in relational data systems, limits the type of data that can be included in the property, as a database administrator is required to define the columns. The system then executes centrally defined rules for the management of the data, which are not specific to varying data types between properties. This creates processing errors and data irregularities in behaviors relating to the data (i.e., calculating price). The present invention is not confined by a table structure, as any authorized party is operable to create a property and assign a value to any object in the ecosystem.

In the AttestationRegistry, data values are assigned to an object's properties through the object's identifier. This is the attestation of the properties of the object, as the values indicate the properties. Data indexing, (i.e., the ability to search and retrieve value) is accomplished via blockchain identifiers for mapping data to blockchain based objects. Therefore, the present invention is operable to assign data to properties and provides for the indexing of the data for any property by an authorized user for any blockchain object or objects. Examples of items with identifiers on distributed ledgers that are operable to be indexed includes but is not limited to: wallets, smart contracts, fungible tokens, objects, and non-fungible tokens. For example, by assigning a value to a property linked to a wallet, wherein the wallet's unique verifiable public key is a proxy for its owner, the public key is an index for the assigned value providing an efficient mechanism for authorized parties to discover and use the assigned value. Similarly, as tokens are used to represent objects, values assigned to properties indexed by the token identifier smart contract are efficiently discoverable by authorized parties.

The present invention advantageously includes multi-level key structures for assigning attestation values to properties of an object or combination of objects. An attestation registry of the invention allows authorized users to create a record of the assigned attestation values of properties included in the object identifier from which a key is made. In this instance, a key is a unique identifier for an object used for indexing. For attestations that join two objects (e.g., the enrollment amount of a wallet in a token offering), the value assigned to the property (e.g., enrollment amount) has a primary key (i.e., the token) and secondary key (i.e., the wallet) for assignment in the attestation registry. In one embodiment, if additional keys are desired (e.g., to join 3 or more objects), an additional key is added to the indexing structure. In one embodiment, for a more general-purpose solution, the values of the key for the additional items are hashed and stored as the secondary key.

Property mapping enables dissimilar classes to share properties and use the same interface of the present invention. This ability of a singular interface to perform operations on dissimilar classes is referred to in the art as polymorphism. In traditional relational databases, data is stored in tabular form with set schema for similar objects, thus dividing them into classes. In some embodiments, dissimilar classes share data. However, traditional schema sharing cuts across multiple classes with different elements shared by a range of classes. For example, bonds and loans share an interest rate policy, bonds and equities share a price property, and US loans and equities share an identifier property (e.g., a CUSIP number). This often leads to data mediation challenges in extract, transform, and load (ETL) operations as operators must decide what columns represent the same property in dissimilar tables.

To facilitate polymorphism in a decentralized network, the present invention identifies properties independent of classes to thereby allow mapping of classes to properties separately. In the attestation registry structure of the present invention, values are assigned to dissimilar classes with the same property identifier. These values are then used to carry out the functions of the present invention on the dissimilar classes, thus facilitating data mediation and polymorphism.

Often, especially in a broad general purpose data storage system, data is assigned to a property of different objects, the data having the same meaning but represented with different units. For example, the area property of an apartment is stored by one system in square feet and another in square meters. The meaning is the same, but a conversion is needed to reconcile the data. While square feet to square meters is a straight-forward conversion, in a system where end-users create an arbitrary number of units, a mechanism to “plug-in” conversion logic is needed. The present invention advantageously enables plug-in unit representation and conversion logic for mediation between different smart contracts through the use of a unit registry, which allows users to create new unit measures and assign them to properties. The term “user” as used herein refers to a wallet address, user device, or user facing portal of a computer platform according to the present invention.

Additionally, smart contract developers are able to create unit conversion logic and register the logic in a united conversion registry to facilitate automated conversions between systems. To facilitate data sharing from smart contract developers and encourage participants to tag objects by assigning relevant data, an economic incentive structure is provided to drive participation by both developers and verification agents.

Referring now to the drawings in general, the illustrations are for the purpose of describing one or more preferred embodiments of the invention and are not intended to limit the invention thereto.

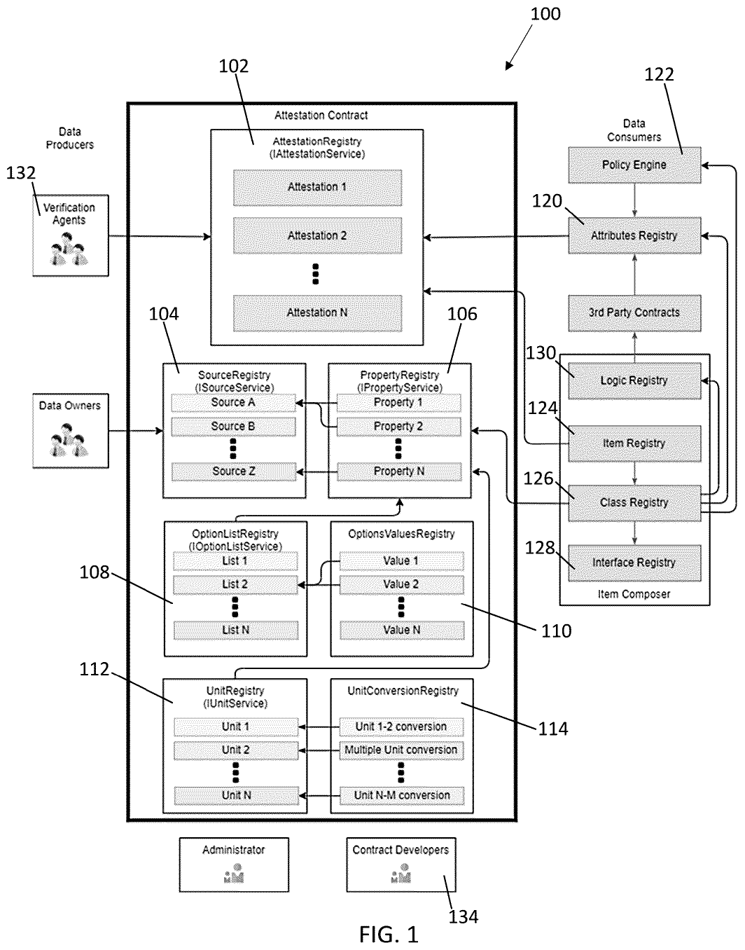

FIG. 1 is a schematic illustration of the architecture of a decentralized computing system according to one embodiment of the present invention. Each element of system 100 is implemented as one or more “modules”, i.e., functional elements including software executed on one or more computing devices. The attestation registry 102 executes the AttestationRegistry smart contract to provide an on-chain DLT data store containing attestations (i.e., assertions made by an authorized party) about an object or joined objects.

The verification agents module 132 is associated with systems of a party that creates behaviors (i.e., data point characteristics, properties, and functions) of objects in the system (e.g., for behaviors uploaded in association with a class). A verification agent has the ability to attest to behaviors associated with objects and classes of the present invention. For example, a verification agent verifies that smart contract code uploaded to the present invention by developers is operable. The attestation registry 102 stores the behaviors of a class which have been verified by a verification agent. In one embodiment, smart contracts and codes of the present invention must be verified by a verification agent before being implemented by the present invention. In one embodiment, smart contracts and codes of the present invention do not require verification by a verification agent before being implemented by the present invention.

The contract developer module 134 is associated with systems of a party that develops smart contract code to be used by the present invention to perform functions associated with an asset class. In one embodiment, to facilitate data sharing from smart contract developers and encourage participants to tag objects by assigning relevant data, an economic incentive structure is provided to drive participation by both developers and verification agents. In one embodiment, the source model includes pricing data, so that contributing developers get paid when contributed data is used elsewhere in the ecosystem. To accomplish this, a token is charged as a fee to data consumers paid to contributing developers in the ecosystem. The fee charged to consumers and reward for developers may be set at the source, property, or attestation. To access the protected data when a fee has been set, the consumer must sign a transaction (e.g., GetData) and pay the fee in the specified token to process the request. In one embodiment, developers receive all of the imposed fee as compensation for the value of contributed data. In one embodiment, a token is charged as a fee to data developers paid to verification agents upon verification of the operability of uploaded data (i.e., a smart contract), wherein the verification agent receives payment when verified data is used elsewhere in the system. In one embodiment, a one-time-fee token is charged to data developers paid to verification agents upon verification of the operability of uploaded data (i.e., a smart contract).

The source registry 104 executes the SourceRegistry smart contract and serves as a grouping structure for data management rights. The property registry 106 executes the PropertyRegistry smart contract and provides data definitions for properties of objects. The data definitions are representations of the data containing descriptive phrases used to distinguish the data from related data. The definitions of the data included in the property registry 106 further advantageously allow data and the associated meaning of the data to be shared across registries, parties, and platforms. The option list registry 108 executes the OptionsListRegistry smart contract and provides an extensible list (i.e., the OptionsList) of enumerations for which a property value has constrained options. The option value registry 110 executes the OptionsValueRegistry smart contract and stores enumerated values for each listed enumeration in the OptionList. The unit registry 112 executes the UnitRegistry smart contract and provides a list of available units that are assigned to attestations. A unit is a standard quantity used to express a physical quantity. Examples of units include but are not limited to meters, kilograms, United States dollars (USD), seconds, and months. The unit conversion registry 114 executes the UnitConversionRegistry smart contract and provides a list of registered smart contracts used to convert data from one property to another unit context in a process known as mediation. In one embodiment, conversion is conducted in terms of data units without converting the property from a digital asset of one distributed ledger to a digital asset of another distributed ledger.

One of ordinary skill in the art will appreciate that the constrained options enumerated within the OptionsList of the OptionsListRegistry defines combinations of variable values, wherein there is some relationship between combinations of those values and payoffs, transfers, ownership, and/or other functions of the present invention. The goal of selecting a constrained option is to select that enumeration which is the optimal combination of the values in the face of a constraint which limits the set of feasible combinations for those available values. The OptionsValueRegistry includes the variable values, combinations of which are stored in the OptionsList of the OptionsListRegistry.

The attributes registry 120 executes the AttributesRegistry smart contract and provides a data map for external data stores and sources. The policy engine 122 executes the PolicyEngine smart contract and is a mechanism to make authorization decisions based on objects and their properties. The item registry 124 executes the ItemRegistry smart contract and provides DLT-based pointers to instances of objects. In one embodiment, these pointers include governance structures. The class registry 126 executes the ClassRegistry smart contract and provides a list of available class templates, a class template mapping the behaviors of a group of similar objects, known as a “class”. Examples of behaviors include but are not limited to properties, functions, events, and interfaces. This class structure supports the concept of class inheritance where a subclass of a parent class inherits attributes of the parent class. This is advantageous for limiting repetition within the system of the present invention, as new child classes are operable to be created including the behavior of the parent class by specifying the parent class and further including novel data structures (e.g., smart contracts) to add functionality to the child class. The interface registry 128 executes the InterfaceRegistry smart contract and provides definitions of properties and functions that support a grouping of behaviors. Interfaces support decentralized polymorphism. The logic registry 130 executes the LogicRegistry smart contract and provides a list of registered smart contracts containing behaviors that are mapped via the class registry.

The ItemRegistry smart contract of the item registry 124 enables the creation and management of objects, an object being a unique instance of a collection of items, the collection sometimes called a class, the instance exhibiting the behaviors the class of items, the behaviors being the interfaces, functions, properties, events, errors, triggers, dependencies, user rights, inter-class relationships, and other characteristics of the class. An object, also referred to as an item, is assigned to a class template in the class registry to exhibit the reusable behaviors of that class. Therefore, the ItemRegistry is a collection of items from many classes, where the classes are defined in the ClassRegistry.

In one embodiment of the present invention, objects exhibit class behavior that extends a basic class, enabling behaviors for objects that represent value within the asset class. This is advantageous for limiting repetition within the system of the present invention, as new classes are operable to be created including the behavior of the basic class by specifying the basic class and further including novel data structures (e.g., smart contracts) to add functionality to the new class. In one embodiment, the objects also include a mechanism to transfer ownership of the value and the object exhibits the behaviors (e.g., ownership transferability) of an asset. The object and the ownership right associated with the object are represented in the system 100 by a unique token. Such a unique token is referred to as a non-fungible token (NFT).

In one embodiment of the present invention, the ItemRegistry smart contract code includes the trusted control plane logic, session management, and permission enforcement for the system, together enabling the composability of objects. An object registered in item registry 124 is a unique and distinct implementation of the behaviors of a class and therefore is non-fungible. Each object has a unique identifier (i.e., the itemId). The unique identifier is combined with the smart contract address listed in the ItemRegistry smart contract of the item registry 124 indicating the wallet associated with the owner of the token to uniquely identify the object globally and immutably. In one embodiment, in addition to other behaviors, the object is assigned standardized ownership and transfer behaviors, resulting in the object implementing the behaviors of a Non-Fungible Token (NFT). Examples of standardized ownership and transfer behaviors include but are not limited to the ERC-721 standard ERC-20 standard, an ERC-777 standard, an ERC-1155 standard, an ERC-223 standard, an ERC-827 standard, an ERC-1337 standard, and an ERC-4626 standard.

Each object in ItemRegistry represents a unique instance of a digital representation of a physical item, examples of which are disclosed herein. A digital representation of the object on the distributed ledger provides an accurate and immutable representation of ownership for the associated physical item. The object further includes an itemID as a unique reference to indicate the location of the desired object data within the distributed ledger. This disclosure advantageously enables user-configurable objects, where the itemID acts as a pointer in the globally distributed virtual machine of a distributed ledger around which behaviors are configured and affected securely and efficiently.

Other examples of objects whose behavior may be implemented in configurable classes within ItemRegistry include but are not limited to equities (including common stock, preferred stock, contributed surplus, additional paid-in capital, and treasury stock), bonds (including but not limited to treasury bonds, government-sponsored enterprise (GSE) bonds, investment-grade bonds, high-yield bonds, foreign bonds, mortgage-backed bonds and municipal bonds), companies, futures, forwards, swaps, options and other derivatives, loans, mortgages, repossessions, collateral and other credit enhancements, insurance policies, real estate, precious metals, motor vehicles, antiques, intellectual property assets, tokens (including tokens issued using the system of the present invention and tokens generated by other systems), and copyright to original works of authorship including literary works, musical works, dramatic works, pantomimes, choreographic works, pictorial works, graphic works, sculptural works, sound recordings, computer programs, and architectural works.

In one embodiment, the item registry 124 is used to create configurable objects for virtual items including, data, documents, cloud or other computing resources, and items that can be viewed or used in a virtual environment such as an online game or a “metaverse” (i.e., a virtual-reality space in which users can interact with a computer-generated environment and other users). Each object in ItemRegistry includes a creator wallet that was used to initiate the creation of the object, a creation date, and a pointer indicating a class in class registry 126 that includes the behaviors of the object. Each class template registered in class registry 126 is a data structure defining the behaviors of objects associated within the class as described below.

In one embodiment, properties are set at the class level, with permission controls defined by the class owner. In one embodiment, objects include additional properties created by the object owner or another party that are not defined by the associated class. In one embodiment, these third-party properties are created and set by any authorized user. This is accomplished, in one embodiment, by a tagging model used to select the permission controls, an asset class, and additional properties. This advantageously simplifies the implementation of code in the present invention, as predefined code is created by developers, verified by verification agents, and implemented to the present invention without requiring a data source to create their own smart contract codes and classes from scratch. For example, a party may assign a rating to a bond object by selecting the smart contract code to be implemented by the bond object, wherein the smart contract code includes a rating for the bond object, the rating being assigned by that party independent of the object ownership structure and class defined properties. In one embodiment, these additional properties are stored as data structures in attribute registry 120.

The class registry 126 enables the creation and management of class templates. The ClassRegistry smart contract of the class registry 126 defines data structures corresponding to all user defined classes (i.e., templates defining the behavior of objects of a class). Each object in the Class Registry defines a class template. The class registry 126 further advantageously enables users to create or extend existing classes without the need for generating new code. This is accomplished by populating a template linking the desired class behavior implemented in existing smart contracts registered in the logic registry 130, and assigning associated properties, data rights, functions and execution rights to this logic. In one embodiment, the class template also defines triggers for event processing.

In one embodiment, a class template is updated to extend and enhance the behaviors of a class. In one embodiment, a class template inherits behaviors from previously defined classes in the ClassRegistry smart contract. By updating or inheriting a class template, the behaviors of an existing class can be reused changing only the differences from the earlier implementation, allowing for efficient reuse of logic and minimal effort to adapt to changing requirements. An implementation of class registry 126 includes an ownership transfer behavior for class templates consistent with the ERC-721 specification (or equivalent on non-Ethereum ledgers) enabling class developers to monetize the value of configured classes and/or transfer this value to others.

In one embodiment, the class template data structure is self-referential. A self-referential class template is created in the ClassRegistry and defines the behaviors of class objects, for example the method to map to properties in the AttestationRegistry. Instances of a class template, user defined classes are recorded and managed in the ItemRegistry, linking the user defined classes to the desired behaviors defined in the ClassRegistry.

The logic registry 130 enables the registration and management of published smart contracts for use in class configuration within the system. The LogicRegistry smart contract of the logic registry 130 stores ownership structure, certification status, and usage pricing data for published logic. The LogicRegistry is also used to manage upgrading of smart contracts and to enable data reuse between upgraded smart contracts using the External Data pattern described herein. One of ordinary skill in the art will appreciate that the process of upgrading smart contracts known as versioning is used to produce upgraded and upgradable smart contracts, known as versioned smart contracts. The LogicRegistry provides a plug-in capability to enable smart contract developers to deploy and register new behaviors for configuration in the ClassRegistry and instantiation by user configured objects.

In one embodiment, the logic of published smart contracts is certified by authorized certification agents through use of any combination of manual code inspection, manual testing, and automated testing thereby providing a list of vetted logic for use in class templates. In one embodiment, the logic must implement a session security model where needed for protected code and publish in a standardized format to be certified. The publication of the logic must include the properties, functions, supported interfaces, events, errors, triggers, and dependencies that provide interaction points for users and other logical elements. In one embodiment, the present invention scans uploaded code for references to third-party functions and contracts. The certifier manually and/or automatically creates restrictions on published logic, enforced at the time of certification, to prevent routing of requests to external logic or data to the identified third parties associated with the third-party functions and contracts to prevent man in the middle attacks from published logic.

In one embodiment, self-describing smart contracts are efficiently configured and combined by class designers who reference smart contracts stored in the logic registry 130 rather than writing new code. In one embodiment, the LogicRegistry also provides interfaces to enable users to easily view classes which reference published logic and stores details about the publisher, publication date, and certification status of the smart contract.

The InterfaceRegistry smart contract of the interface registry 128 enables the registration and management of published interface specifications (i.e., computer code that defines the format for interaction with smart contract properties, functions, events, errors, and dependencies without an explicit implementation of the behavior). An interface is a syntactical format used for all interactions with published logic. An interface groups functions, properties, events, and errors that are expected as a result of the implementation of logic. The interface defines the ‘what’ part of the syntactical format and the implementing logic defines the ‘how’ part of the syntactical format. Interfaces are used to enhance interoperability through substitutability, a concept known in computer science as polymorphism. Polymorphism is an important aspect to enable scalability of an ecosystem of dissimilar but related objects by enabling a single implementation of logic that acts on common behaviors of dissimilar classes of objects. When interfaces are implemented, classes may substitute one smart contract indicating a behavior represented by the interface for another. For example, logic that instantiates the behavior of a bond is very different than logic that instantiates the behavior of a mortgage. However, both include an interest rate. When implementing logic that operates on the interest rate of an object, the present invention provides a common interface to permit the operation of the logic on these dissimilar objects without coding for each class.

The use of the interface registry 128 decentralizes the deployment of interfaces, thereby enabling an ecosystem to consolidate around useful patterns without the need for central control of standards. This innovation is designed to manage the scale and complexity of plug-in logic and user defined classes. The InterfaceRegistry provides a mechanism by which end users are able to publish, register, and describe useful behaviors that are expected to be present across classes (i.e., user defined interfaces). The InterfaceRegistry creates the conditions by which common patterns are identified though sharing of useful interfaces. Registered interfaces also facilitate the development of automated integration tests that verify the proper behavior of register logic.

The InterfaceRegistry further promotes interoperability between logical elements and facilitates complex behavior in the ecosystem by enabling elements to work with a range of dissimilar objects with similar characteristics. For example, bonds, derivatives, and equity are dissimilar in many respects but all exhibit price properties. Interfaces allow higher level processes to use this similarity to perform price operations on instances of each class. Through the use of a standardized interface, a developer plugs in a new implementation of a service to an object without modifying dependent code, such as upgrading to an oracle that provides a more accurate conversion rate at a particular point in time.

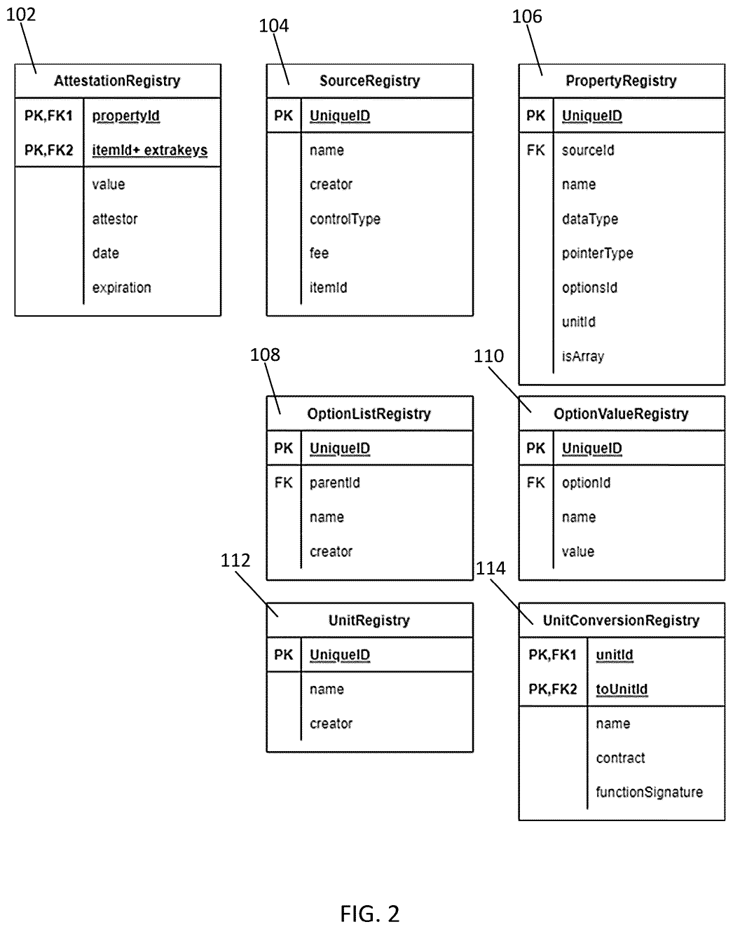

FIG. 2 illustrates the structure of a data schema for decentralized management of data in an object-oriented system according to one embodiment of the present invention. The data schema illustrate the interoperability of attestation registry 102, the source registry 104, the property registry 106, the options list registry 108, the option value registry 110, the unit registry 112, and the unit conversion registry 114. The data schema include one or more a primary keys (e.g., PK) in a table and one or more foreign keys (e.g., FK, FK1, FK2) in a table. The foreign key is a primary key of a foreign data schema which points to desired data located within a separate data table. The foreign key is used to access a data schema (e.g., a smart contract UnitConversionRegistry uses a foreign key to access the name, contract, or functionSignature). In one embodiment, the foreign key is a pointer indicating the location of desired data (i.e., a name, creator, unitid). In one embodiment, the data included in the data schema is one or more pointers indicating the location of the desired data. In one embodiment, the pointers of the present invention indicate data within the system of the present invention. In one embodiment, the pointers of the present invention indicate data on a third party platform. Each transaction is affected by signing a transaction on the blockchain ledger referencing the AttestationRegistry smart contract.

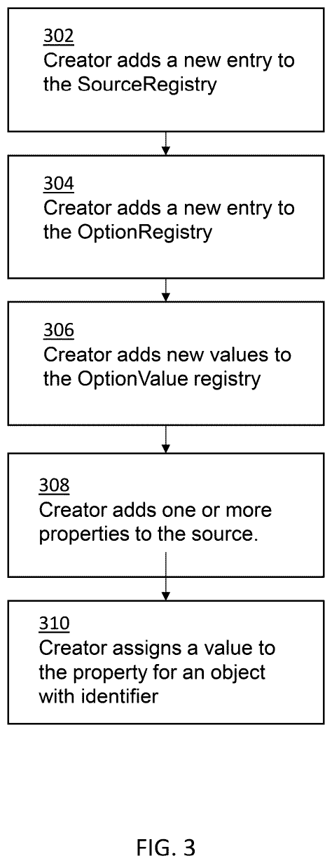

FIG. 3 is a flowchart of a process for entering data control information according to one embodiment of the present invention. FIG. 3 illustrates a process of recording the transactions in accordance with the data schema of FIG. 2. At 302, a creator adds a new entry to the SourceRegistry in the form of a data structure representing a governance model for one or more properties as described herein. At step 304, the creator adds a new entry to the Option Registry. At 306, the creator adds new values to the OptionValue registry. At 308, the creator adds one or more properties to the source. At 310, the creator assigns a value to the property for an object with an identifier, (e.g., objectId). An exemplary entry is in the form of the following data structure:

```
Source: name = “RatingAgency”, creator=[Creator wallet], controlType
  = owner, fee=null, itemId=null
OptionList: name = “Ratings”, parentId = null
OptionValue: optionId = [Ratings optionId], name = “AAA”
OptionValue: optionId = [Ratings optionId], name = “BBB”
Property: name = Rating, datatype = string, pointerType = null,
  optionsId=Ratings, unitId=null, isArray=false, sourceId=[Rating
  sourceId]
Attestation: propertyId=[Rating propertyId], itemId=[objectId],
  value=”AAA”, creator=[Creator wallet], date=[now], expiration =
  null
```

The term “source” used herein refers to a grouping of properties and data to facilitate decentralized data rights management. The disclosed implementation includes methods to create a decentralized ecosystem of data consumers and producers. One aspect of building this ecosystem is the reliability and accountability of data sources (i.e., trust). To build this trust, users must ensure that data pertaining to a property is posted by an authorized and qualified source with full attribution.

With a wide range of data participation models expected, a range of control methods are required to cover expected patterns for data management. Control models are assigned to a source and/or an object that designates a party or parties authorized to edit the data associated with the object. In one embodiment, the verification agent verifies a request to edit data by evaluating the authorization of a party or parties submitting the request. In one embodiment, the verification agent compares the party or parties submitting the request to the party or parties authorized by an authorization control model. Authorization control models include but are not limited to the following:
Private—Property editable by trusted smart contracts.
Protected—creatorControlled. Property editable by source creator.
Protected—ownerControlled. Property editable by the current owner of the object in the Item Registry with an itemId as specified by the source assigned to the property. This is a frequently used control for properties assigned to NFTs. Since NFTs are transferable and the owner is part of the NFT interface structure and therefore is known at any time, this control pattern simplifies rights management for frequent ownership transfer between parties.
Protected—roleEnforced. Role Based Access Control (RBAC). Property editable by evaluating if the caller is a member of the Owner or Editor group assigned to the property's source.
Protected—policyEnforced. Attribute Based Access Control (ABAC). Property editable by consulting with a Compliance Oracle to evaluate the right to edit based on configurable policies.
Protected—daoEnforced. Decentralized Autonomous Organization (DAO). Property editable by consulting with a Decentralized Autonomous Organization, via a vote, to evaluate make the requested data change. The mechanism to consult a DAO for the proposed state change is discussed in the U.S. patent application Ser. No. 17/332,375, incorporated herein by reference in its entirety.
Public—Editable by any party

The private control setting allows a smart contract mapped to the class to update properties for another smart contract mapped to the class if the properties are connected. This control model only allows requests for data editing from trusted smart contract sources, such as the ItemRegistry smart contract. In one embodiment, the administrator of the AttestationRegistry smart contract assigns the trust relationship by calling the AttestationRegistry.AssignTrustedSource smart contract address to assign trust to a smart contract to enable updates to properties marked as private. In one embodiment, any request for data editing sent to a property assigned the private control model that does not originate from a trusted contract is rejected.

In one embodiment, protected control is accomplished using a compliance oracle that is implemented as a module and includes a smart contract, ComplianceOracle, that permits the creation and enforcement of complex policies (i.e., rulesets that are evaluated to determine if a proposed state change on the DLT is authorized). In one embodiment, a rule exists in the form: attribute, comparison operator, attribute, operator, attribute. In one embodiment, the operator and the final attribute are null. In one embodiment, an attribute is a variable assigned an attestation in the context of a transaction. In one embodiment, an attribute may be a constant. One exemplary rule is CreditScore GreaterThan 750, wherein the ComplianceOracle indicates the location of a credit score attribute within the attestation registry or via a third party. Another exemplary rule is MedicalPractitioner Equals True, wherein the ComplianceOracle indicates the location of a medical practitioner attribute within the attestation registry or via a third party. In one embodiment, rules are combined into rulesets which are evaluated as policy to enable an authorization decision (i.e., allow or prevent a proposed state change) by a policy enforcement point. For the exemplary rule CreditScore GreaterThan 750, once the credit score attribute of the previous example is located, the policy enforcement point verifies the credit score attribute is greater than 750. For the exemplary rule MedicalPractitioner Equals True, once the medical practitioner attribute of the is located, the policy enforcement point verifies the attribute equals true. An example of the role of a compliance oracle is described in U.S. patent application Ser. No. 16/143,058, incorporated herein by reference in its entirety.

The compliance oracle leverages policies that determine the authorization of a proposed state change by interpreting the policy and the data. In one embodiment, the policies leveraged by the oracle are byte code representing the rules to be enforced published to an on-chain policy enforcement “oracle.” In one embodiment, the data interpreted by the oracle is posted from external sources, including off-chain sources. In one embodiment, the compliance oracle is consulted as part of the trusted control mechanism to verify the authorization of a proposed request in the trusted control mechanism.

In one embodiment, the ComplianceOracle smart contract references data from smart contracts AttributeRegistry and AttestationRegistry. These smart contracts provide a smart-contract-based general purpose data management layer with flexible controls to enable a decentralized coalition of participants. The smart-contract-based general purpose data management layer is operable to define data schema, share data, mediate between differing formats for data consumption, track provenance and data staleness, and manage access and authority to create, update, and delete decentralized data. These smart contracts allow the creation of arbitrary properties referred to herein as “attributes.” The terms “attributes” and “properties” are used interchangeably herein. Attributes are assigned to classes or object instance and populated with values based on authorized internal or external sources. The AttributeRegistry advantageously enables robust and flexible control of data rights for objects through the use of selectable smart contract code. This facilitates broad use of the framework of the present invention. The AttestationRegistry records the values assigned to attributes for specific objects. For example, in one embodiment, a class template includes a property for an interest rate that set and maintained by the London Inter-Bank Offered Rate (LIBOR). A specific entity is authorized to publish LIBOR data. A smart contract registered in logic registry 130 depends on this published value in its processing logic but does not control the authority by which this value is set. The AttributeRegistry includes logic that enforces the right to publish this data. The class template links the property used by the smart contract to the corresponding attributes in the AttributeRegistry. As a new value is assigned in the AttestationRegistry, the smart contract logic has access to this value, automatically updating the value in the attestation registry. In one embodiment, as a new value is assigned in the AttestationRegistry, the smart contract logic automatically updates the value in the attestation registry. In one embodiment, the class template links the property used by the smart contract to the corresponding attributes in the AttributeRegistry through the use of a pointer, wherein the pointer indicates the location of the updated data.

In one embodiment, creator controlled sources rely on a central authority (i.e., the creator) to write data. The source creator maintains the right to add properties to the context and assign attestations for those properties. In one embodiment, the creator specifies a Role Based Access Control (RBAC) model for control of context properties and data. If RBAC is selected, two default roles are available for the source, an owner role and an editor role. In one embodiment, the creator assigns one or more wallets to the owner role and/or the editor role by entering a value in the Attestation Registry referencing the sourceId, propertyId (i.e., a propertyId for the owner role or a propertyId for the editor role), and a value representing the wallet being granted the right. Rights enabled by the assignment of the owner role include but are not limited to creating, updating, or deleting any attestation in the context. Rights enabled by the assignment of the editor role include but are not limited to creating, updating, or deleting any attestation in the context for which they are the creator.

In one embodiment, the creator specifies an Attribute Based Access Control (ABAC) model for control of context properties and data. If ABAC is selected, one default property (i.e., policy) is available for the source. The policy defines a compliance oracle policy applied to determine if the party has edit rights. The compliance oracle is a flexible model used to create complex policies that make authorization decisions based on attributes of the user and the affected objects. Operations of the compliance oracle are disclosed in U.S. patent application Ser. No. 16/143,058, incorporated herein by reference in its entirety.

In one embodiment, the creator specifies a public control model for control of context properties and data. The public control model allows any party with a wallet to edit context data.

On a public distributed ledger network, parties engaged in a wide range of activities require complex models for managing attestation authority from diverse sources. The power of these flexible data source control models to manage complex real world authority management models is illustrated in the following example. For example, in one embodiment, a system on a distributed ledger network used for medical payments utilizes the properties “PatientHealth” and “CreditScore” assigned to a wallet representing an individual. Attestations regarding each of these properties are be made by sources with very different qualifications. Attestation for the PatientHealth property requires attestation by a licensed medical professional, while attestation of the CreditScore property requires attestation by a credit analyst of a licensed financial institution. To maintain the integrity of attestations for a property, the source context managing each property will assign the right to attest through the control context as described above. In one embodiment, attestations are nested within each other, as the attestation of a PatientHealth property is accomplished by a qualified medical practitioner, which is itself a property (i.e., MedicalPractitioner) that is an attestation made by a regulatory body (e.g., a medical board). Membership on the medical board, “MedicalBoard” is a further attestation ultimately established by the root right, (i.e., an attestor and/or verification agent representing the authority of the medical board). This root is the authority who establishes the source control context by signing the transaction to create the source in the source registry to manage the right for all properties utilized in this example.

To accomplish a scalable ecosystem of medical attestations, a creator who has been assigned the authority to administer the medical attestation ecosystem adds a new entry to the governance model SourceRegistry. Using the authority as creator of the source, the creator attests to the editor status for members of the Boards, assigning a role within the source the source to make attestations. The creator then creates a property (i.e., MedicalPractitioner) that is assigned by members of the board to the wallet of the medical practitioner. Using the authority as an editor as assigned by the creator in the RBAC control context of the source, a board member attests to the status of a licensed medical practitioner. An exemplary source entry for this data is a data structure in the form of.

```
Source: name = “MedicalBoard”, creator=[Medical Board representative
  wallet], controlType = role, fee=null, itemId=null
Attestation: propertyId=[Editor propertyId], itemId=[sourceId], [member
  walletId], value=”true”, creator=[Creator wallet], date=[now],
  expiration = null
Property: name = MedicalPractitioner, datatype = boolean, pointerType =
  null, optionsId=null, unitId=null, isArray=false,
  sourceId=[MedicalBoard sourceId]
Attestation: propertyId=[MedicalPractitioner propertyId],
  itemId=[practitioner walletId], value=”true”, creator=[member
  walletId], date=[now], expiration = 1year
```

The creator then creates a new entry in SourceRegistry, a data structure representing a governance model for medical statements. In this case the source is assigned a policy for making attestations to the MedicalStatements property, the policy being identified by policyId. A policy is a set of rules interpreted by a policy enforcement point in the context of a proposed state change to allow or disallow the change. Here, policyid refers to a simple policy requiring the party making the state change request to have an attestation MedicalPractitioner Equals True. The creator then creates a property, Medical Practitioner, that is assigned to individual's wallets by members of the board. Using the authority enforced by the assigned policy in the ABAC control context of the source (ex. MedicalPractitioner Equals True), a medical practitioner attests to the status of a patient. An exemplary source entry for this data is a data structure in the form of:

```
Source: name = “MedicalStatements”, creator=[Medical Board
  representative wallet], controlType = policy, fee=null,
  itemId=[MedicalStatements policyId]
Property: name = PatientHealth, datatype = string, pointerType =
  null, optionsId=null, unitId=null, isArray=false,
  sourceId=[MedicalStatements sourceId]
Attestation: propertyId=[PatientHealth propertyId], itemId=[patient
  walletId], value=”Good”, creator=[practioner walletId],
  date=[now], expiration = 1year
```

The flexibility of the source control context allows a scalable system by which all statements and the source of their authority are traced at ecosystem scale. The need for such a system is evidenced by the difficulty in certifying the degrees and credentials of parties both within and across varying jurisdictions. This difficulty in certifying the degrees and credentials of parties is acute when sharing data across financial service providers. Attestations on simple properties such as the price of an asset, the regulatory status of the asset, assigned ownership, and the qualifications of investors are notoriously difficult to reconcile. The present invention advantageously resolves this challenge by enabling a DLT-based ecosystem of trusted attestations with each element of data having full provenance (i.e., detailed and immutable data history). In one embodiment, the present invention does not include attestations for a user device. In one embodiment, the attestations of present invention are directed to the attributes and behaviors of the digital asset. In one embodiment, the attestations of present invention are directed to the attributes, wallets, and behaviors of the digital asset. The digital asset is referred to herein as a “property”.

Basic data types are supported for properties. Examples of basic data types include but are not limited to Boolean data types, integer data types, decimal data types, string data types, and date/time data types. The system also supports complex data types. Examples of complex data types include but are not limited to files, pointers, and objects. It should be noted that the term “pointers” as used herein refers to pointers including but not limited to cryptographic hash pointers, null pointers, dangling pointers, void pointers, function pointers, and uninitialized pointers. The use of these complex data types enable flexibility in nested data mapping and polymorphism such that pointers are used to refer to data in adjacent registries and classes. This advantageously removes the need to renumerate data that is shared between classes. For example, in one embodiment, an authorized user seeks to add a property PostedCollateral for a collateral posted against a loan. The PostedCollateral property is added to the system with a class template CollateralClass, which includes an identifier collateralClassId. Attestations for this property assign objects of the CollateralClass to the associated object. The associated object smart contract then operates on the CollateralClass object by calling the functions and behaviors assigned to assets within the CollateralClass.

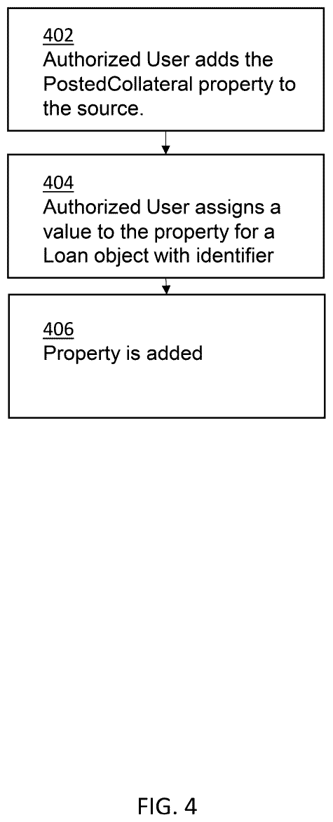

FIG. 4 is a flowchart of a process for assigning properties to a source according to one embodiment of the present invention. The specific example of FIG. 4 illustrates the process for assigning a tokenized collateral to a tokenized loan according to one embodiment of the present invention. The CollateralClass object (i.e., the tokenized collateral) includes an identifier collateralId. The loan token (i.e., the tokenized loan) includes an identifier loanId. At 402 an Authorized User adds the PostedCollateral property to the source. At 404, the Authorized User assigns a value to the property for a Loan object with identifier a loanId identifier. At 406, the assigned property is added to the AttestationRegistry. An exemplary data structure executing this process is:

```
Property: name = PostedCollateral, datatype = object, pointerType =
  [collateralClassId], optionsId=null, unitId=null, isArray=false
Attestation: propertyId=[ PostedCollateralPropertyId],
  itemId=[loanId], value=[collateralId], creator=[user wallet],
  date=[now], expiration = null
```

This structure allows objects to reference other objects as properties. Since the property has a defined type specified by the pointerType field (i.e., the property is strong typed), the behaviors (e.g., properties, functions, events, and errors) of the assigned object are known. In one embodiment, the behaviors are referenced in the smart contract code of a parent object and any requests submitted to the object are routed for processing using the methods for routing requests for strongly typed objects. One of ordinary skill in the art will appreciate that there are a variety of methods for routing requests for strongly typed objects, examples and code for which have not been included herein for the sake of brevity but are considered to be within the scope of the invention.

In one embodiment, a parent Loan object calls a Collateral.Forward function for the assigned collateral object of FIG. 4 if the loan's default condition is met. In one embodiment, the Loan object makes a collateral call of the loan recipient if the Collateral.Price property is below the principal value of the loan. In one embodiment, the present invention utilizes nested calls. For example, if the loan is assigned to a property in a fund, a smart contract of the fund calls the object pointer of the Collateral property assigned to the object pointer of the Loan property to call the collateral price Loan.Collateral.Price.

In one embodiment, when a value is set via the AttestationRegistry for a property with an object datatype, the AttestationRegistry smart contract code initiates a request to the ItemRegistry.ImplementsClass smart contract function for a validation process, wherein the ItemRegistry.ImplementsClass smart contract function verifies that the object typeId assigned to the object matches the pointerType. If the object referenced by the value that is proposed for the property does not implement the class assigned to the property's pointerType, a TypeMismatch(objectId, pointerTypeId) error is produced and the request to set data (e.g., the value) is rejected.

In one embodiment, a property with an interface datatype follows the same method as object. when a value is set via the AttestationRegistry for a property with an interface datatype, the AttestationRegistry smart contract code initiates a request to the ItemRegistry.ImplementsInterface smart contract function for a validation process, wherein the ItemRegistry.ImplementsInterface smart contract function verifies that the interface typeId assigned to the interface matches the pointerType. If the interface referenced by the value that is proposed for the property does not implement the interface assigned to the property's pointerType, an error (e.g., a TypeMismatch(interfaceId, pointerTypeId) error) is produced and the request to set data for the property is rejected.

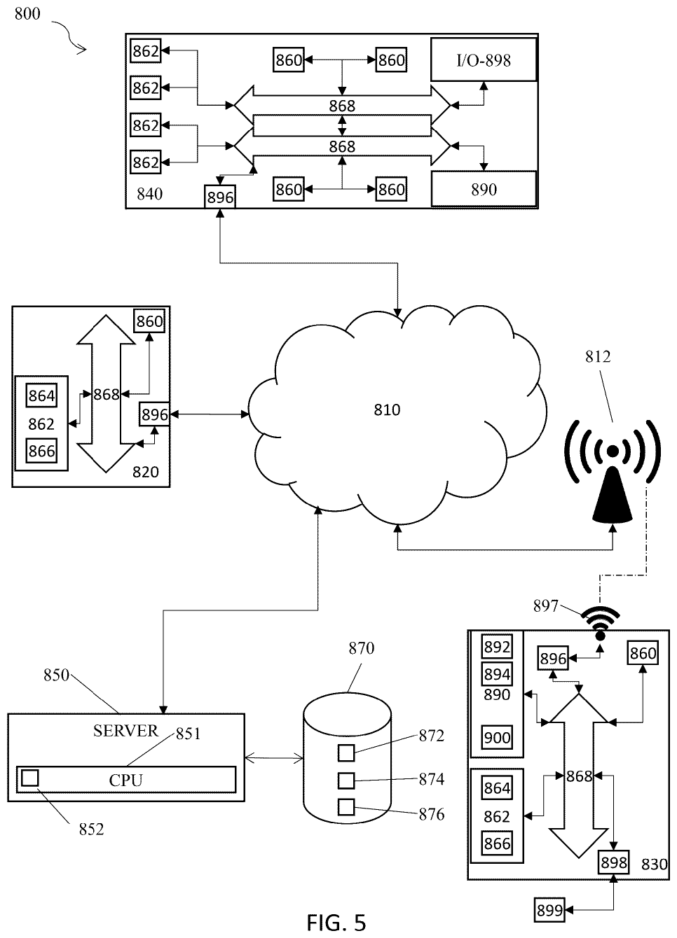

FIG. 5 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 5, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 5, is operable to include other components that are not explicitly shown in FIG. 5, or is operable to utilize an architecture completely different than that shown in FIG. 5. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Data Stored on a Distributed Ledger

In a preferred embodiment, the platform is operable to store data on a distributed ledger, e.g., a blockchain. Distributed ledger technology refers to an infrastructure of replicated, shared, and synchronized digital data that is decentralized and distributed across a plurality of machines, or nodes. The nodes include but are not limited to a mobile device, a computer, a server, and/or any combination thereof. Data is replicated and synchronized across a network of nodes such that each node has a complete copy of the distributed ledger. The replication and synchronization of data across a distributed set of devices provides increased transparency over traditional data storage systems, as multiple devices have access to the same set of records and/or database. Additionally, the use of distributed ledgers eliminates the need for third party and/or administrative authorities because each of the nodes in the network is operable to receive, validate, and store additional data, thus creating a truly decentralized system. Eliminating the third party and/or administrative authorities saves time and cost. A decentralized database is also more secure than traditional databases, which are stored on a single device and/or server because the decentralized data is replicated and spread out over both physical and digital space to segregated and independent nodes, making it more difficult to attack and/or irreparably tamper with the data. Tampering with the data at one location does not automatically affect the identical data stored at other nodes, thus providing greater data security.

In addition to the decentralized storage of the distributed ledger, which requires a plurality of nodes, the distributed ledger has further advantages in the way that data is received, validated, communicated, and added to the ledger. When new data is added to the distributed ledger, it must be validated by a portion of the nodes (e.g., 51%) involved in maintaining the ledger in a process called consensus. Proof of work, proof of stake, delegated proof of stake, proof of space, proof of capacity, proof of activity, proof of elapsed time, and/or proof of authority consensus are all compatible with the present invention, as are other forms of consensus known in the art. In one embodiment, the present invention uses fault-tolerant consensus systems. Each node in the system is operable to participate in consensus, e.g., by performing at least one calculation, performing at least one function, allocating compute resources, allocating at least one token, and/or storing data. It is necessary for a portion of the nodes in the system (e.g., 51% of the nodes) to participate in consensus in order for new data to be added to the distributed ledger. Advantageously, requiring that the portion of the nodes participate in consensus while all nodes are operable to participate in consensus means that authority to modify the ledger is not allocated to one node or even a group of nodes but rather is equally distributed across all of the nodes in the system. In one embodiment, a node that participates in consensus is rewarded, e.g., with a digital token, in a process called mining.

The blockchain is a commonly used implementation of a distributed ledger and was described in Satoshi Nakamoto's whitepaper Bitcoin: A Peer-to-Peer Electronic Cash System, which was published in October 2008 and which is incorporated herein by reference in its entirety. In the blockchain, additional data is added to the ledger in the form of a block. Each block is linked to its preceding block with a cryptographic hash, which is a one-way mapping function of the data in the preceding block that cannot practically be computed in reverse. In one embodiment, a timestamp is also included in the hash. The computation of the cryptographic hash based on data in a preceding block is a computationally intensive task that could not practically be conducted as a mental process. The use of cryptographic hashes means that each block is sequentially related to the block before it and the block after it, making the chain as a whole immutable. Data in a block in a preferred embodiment cannot be retroactively altered after it is added to the chain because doing so changes the associated hash, which affects all subsequent blocks in the chain and which breaks the mapping of the preceding block. The blockchain is an improvement on existing methods of data storage because it connects blocks of data in an immutable fashion. Additionally, the blockchain is then replicated and synchronized across all nodes in the system, ensuring a distributed ledger. Any attempted changes to the blockchain are propagated across a decentralized network, which increases the responsiveness of the system to detect and eliminate fraudulent behavior compared to non-distributed data storage systems. The blockchain and the distributed ledger solve problems inherent to computer networking technology by providing a secure and decentralized way of storing data that is immutable and has high fault tolerance. The distributed ledger stores digital data and is thus inextricably tied to computer technology. Additional information about the blockchain is included in The Business of Blockchain by William Mougavar published in April 2016, which is incorporated herein by reference in its entirety.

In one embodiment, the data added to the distributed ledger of the present invention include digital signatures. A digital signature links a piece of data (e.g., a block) to a digital identity (e.g., a user account). In one embodiment, the digital signature is created using a cryptographic hash and at least one private key for a user. The content of the piece of data is used to produce a cryptographic hash. The cryptographic hash and the at least one private key are used to create the digital signature using a signature algorithm. The digital signature is only operable to be created using a private key. However, the digital signature is operable to be decoded and/or verified using a public key also corresponding to the user. The separation of public keys and private keys means that external parties can verify a digital signature of a user using a public key but cannot replicate the digital signature since they do not have a private key. Digital signatures are not merely electronic analogs of traditional physical signatures. Physical signatures are easily accessible and easily replicable by hand. In addition, there is no standard algorithm to verify a physical signature except comparing a first signature with a second signature from the same person via visual inspection, which is not always possible. In one embodiment, the digital signatures are created using the data that is being linked to the digital identity whereas physical signatures are only related to the identity of the signer and are agnostic of what is being signed. Furthermore, digital signatures are transformed into a cryptographic hash using a private key, which is a proof of identity of which there is no physical or pre-electronic analog. Digital signatures, and cryptographic hashes in general, are of sufficient data size and complexity to not be understood by human mental work, let alone verified through the use of keys and corresponding algorithms by human mental work. Therefore, creating, decoding, and/or verifying digital signatures with the human mind is highly impractical.

Public, private, consortium, and hybrid blockchains are compatible with the present invention. In one embodiment, the blockchain system used by the present invention includes sidechains wherein the sidechains run parallel to a primary chain. Implementations of distributed ledger and/or blockchain technology including, but not limited to, BITCOIN, ETHEREUM, HASHGRAPH, BINANCE, FLOW, TRON, TEZOS, COSMOS, and/or RIPPLE are compatible with the present invention. In one embodiment, the platform includes at least one acyclic graph ledger (e.g., at least one tangle and/or at least one hashgraph). In one embodiment, the platform includes at least one quantum computing ledger.

In one embodiment, the present invention further includes the use of at least one smart contract, wherein a smart contract includes a set of automatically executable steps and/or instructions that are dependent on agreed-upon terms. The smart contract includes information including, but not limited to, at least one contracting party, at least one contract address, contract data, and/or at least one contract term. In one embodiment, the at least one smart contract is deployed on a blockchain such that the at least one smart contract is also stored on a distributed node infrastructure. In one embodiment, the terms of the at least one smart contract are dependent on changes to the blockchain. For example, a provision of the at least one smart contract executes when a new block is added to the blockchain that meets the terms of the at least one smart contract. The smart contract is preferably executed automatically when the new block is added to the blockchain. In one embodiment, a first smart contract is operable to invoke a second smart contract when executed. A smart contract is operable to capture and store state information about the current state of the blockchain and/or the distributed ledger at any point in time. Advantageously, a smart contract is more transparent than traditional coded contracts because it is stored on a distributed ledger. Additionally, all executions of the smart contract are immutably stored and accessible on the distributed ledger, which is an improvement over non-distributed, stateless coded contracts. In one embodiment, the state information is also stored on a distributed ledger.

Cryptocurrency Transactions

Distributed ledger technology further enables the use of cryptocurrencies. A cryptocurrency is a digital asset wherein ownership records and transaction records of a unit of cryptocurrency (typically a token) are stored in a digital ledger using cryptography. Use of centralized cryptocurrencies and decentralized cryptocurrencies are both compatible with the present invention. Centralized cryptocurrencies are minted prior to issuance and/or are issued by a single body. Records of a decentralized cryptocurrency are stored on a distributed ledger (e.g., a blockchain), and any node participating in the distributed ledger is operable to mint the decentralized cryptocurrency. The distributed ledger thus serves as a public record of financial transactions. Cryptocurrencies are typically fungible in that each token of a given cryptocurrency is interchangeable. The present invention is operable to facilitate transactions of at least one cryptocurrency, including, but not limited to, BITCOIN, LITECOIN, RIPPLE, NXT, DASH, STELLAR, BINANCE COIN, and/or ETHEREUM. In one embodiment, the present invention is operable to facilitate transactions of stablecoins, NEO Enhancement Protocol (NEP) tokens, and/or BINANCE Chain Evolution Proposal (BEP) tokens. In one embodiment, the present invention is operable to support tokens created using the ETHEREUM Request for Comment (ERC) standards as described by the Ethereum Improvement Proposals (EIP). For example, the present invention is operable to support ERC-20-compatible tokens, which are created using the EIP-20: ERC-20 Token Standard, published by Vogelsteller, et al., on Nov. 19, 2015, which is incorporated herein by reference in its entirety.

A cryptocurrency wallet stores keys for cryptocurrency transactions. As cryptocurrency is a virtual currency, the ability to access and transfer cryptocurrency must be protected through physical and/or virtual means such that such actions are only operable to be performed by the rightful owner and/or parties with permission. In one embodiment, a cryptocurrency wallet stores a private key and a public key. In another embodiment, the cryptocurrency wallet is operable to create the private key and/or the public key, encrypt data, and/or sign data (e.g., with a digital signature). In one embodiment, the private key is generated via a first cryptographic algorithm wherein the input to the first cryptographic algorithm is random. Alternatively, the input to the first cryptographic algorithm is non-random. In one embodiment, the public key is generated from the private key using a second cryptographic algorithm. In one embodiment, the first cryptographic algorithm and the second cryptographic algorithm are the same. The private key is only accessible to the owner of the cryptocurrency wallet, while the public key is accessible to the owner of the cryptocurrency wallet as well as a receiving party receiving cryptocurrency from the owner of the cryptocurrency wallet. Deterministic and non-deterministic cryptocurrency wallets are compatible with the present invention.

As a non-limiting example, a cryptocurrency transaction between a first party and a second party involves the first party using a private key to sign a transaction wherein the transaction includes data on a first cryptocurrency wallet belonging to the first party, the amount of the transaction, and a second cryptocurrency wallet belonging to the second party. In one embodiment, the second cryptocurrency wallet is identified by a public key. The transaction is then populated to a distributed network wherein a proportion (e.g., 51%) of the nodes of the distributed network verify the transaction. Verifying the transaction includes verifying that the private key corresponds to the first cryptocurrency wallet and that the amount of the transaction is available in the first cryptocurrency wallet. The nodes then record the transaction on the distributed ledger, e.g., by adding a block to a blockchain. Fulfilling the cryptocurrency transaction is a computationally intensive process due to key cryptography and the consensus necessary for adding data to the distributed ledger that could not practically be performed in the human mind. In one embodiment, a node is operable to verify a block of transactions rather than a single transaction.

Desktop wallets, mobile wallets, hardware wallets, and web wallets are compatible with the present invention. A software wallet (e.g., a desktop wallet, a mobile wallet, a web wallet) stores private and/or public keys in software. A hardware wallet stores and isolates private and/or public keys in a physical unit, e.g., a universal serial bus (USB) flash drive. The hardware wallet is not connected to the internet or any form of wireless communication, thus the data stored on the hardware wallet is not accessible unless the hardware wallet is connected to an external device with network connection, e.g., a computer. In one embodiment, the data on the hardware wallet is not operable to be transferred out of the hardware wallet. In one embodiment, the hardware wallet includes further data security measures, e.g., a password requirement and/or a biometric identifier requirement. In one embodiment, the present invention is operable to integrate a third-party cryptocurrency wallet. Alternatively, the present invention is operable to integrate a payments platform that is compatible with cryptocurrency, including, but not limited to, VENMO, PAYPAL, COINBASE, and/or payments platforms associated with financial institutions.

Tokenization

In one embodiment, the platform is operable to tokenize assets. A token is a piece of data that is stored on the distributed digital ledger and that can be used to represent a physical and/or a digital asset, e.g., in a transaction, in an inventory. The token is not the asset itself; however, possession and transfer of the token are stored on the distributed digital ledger, thus creating an immutable record of ownership. In one embodiment, the token includes cryptographic hashes of asset data, wherein the asset data is related to the asset. In one embodiment, the asset data is a chain of data blocks. For example, the asset is a work of digital art, and the asset data includes data about the work such as information about an artist, a subject matter, a file type, color data, etc. The corresponding token includes a cryptographic hash of the asset data, which describes the work. Alternative mappings of the asset data to the token are also compatible with the present invention. In one embodiment, the token is a non-fungible token (NFT). A first non-fungible token is not directly interchangeable with a second non-fungible token; rather, the value of the first token and the second token are determined in terms of a fungible unit (e.g., a currency). In one embodiment, the platform is operable to support ETHEREUM standards for tokenization, including, but not limited to, EIP-721: ERC-721 Non-Fungible Token Standard by Entriken, et al., which was published Jan. 24, 2018 and which is incorporated herein by reference in its entirety. In one embodiment, the platform is operable to create fractional NFTs (f-NFTs), wherein each f-NFT represents a portion of the asset. Ownership of an f-NFT corresponds to partial ownership of the asset.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A method of managing trusted data on a decentralized network, comprising:
creating a property registry on a computer platform, wherein the computer platform is implemented on a distributed ledger;
the property registry storing at least one data definition, wherein a property including a name, a data type, and a source is defined by the at least one data definition, wherein the property is stored in the property registry;
a source registry executing a smart contract to access the property stored in the property registry;
adding the property to the source registry, the source registry deploying a smart contract assigning authorization to a smart contract address to enable the smart contract address to access, edit, and/or delete the property;
the source registry executing a smart contract for verifying authorization to access, edit, and/or delete the property; and
assigning at least one value to the property and storing the at least one value in a memory of a value registry.

2. The method of claim 1, wherein the at least one value stored in the memory of the value registry is automatically updated when the at least one value is updated.

3. The method of claim 1, wherein the data type is a Boolean data type, an integer data type, a decimal data type, a string data type date and time data type, an object data type, and/or a pointer data type.

4. The method of claim 1, wherein the data type is a pointer data type, wherein the pointer data type points to a second pointer data type of a second property, wherein the second pointer data type points to a value.

5. The method of claim 1, wherein authorization of the smart contract address to access, edit, and/or delete the property is granted based on a role of the smart contract address, an attribute of the smart contract address, a policy of the smart contract address, authorization granted to the smart contract address by a property owner, and/or authorization granted to the smart contract address by a property creator.

6. The method of claim 1, wherein the source registry implements an oracle smart contract for creation and/or identification of at least one complex policy.

7. The method of claim 1, wherein a property is created using a class registry, wherein the class registry stores a class template, the class template mapping at least one behavior including an event, an interface, and/or a function, wherein a class template is selected from the class registry to enable the property to inherit the at least one behavior mapped by the class template.

8. The method of claim 7, further comprising adding at least one additional behavior, including at least one additional event, at least one additional interface, and/or at least one additional function to the class template to produce a new class template, wherein the property displays the at least one behavior and the at least one additional behavior.

9. The method of claim 1, further comprising at least one developer updating the code of the smart contract for accessing the property stored in the property registry, the smart contract assigning authorization to a smart contract address, and/or the smart contract for verifying authorization.

10. A system for management of data on a decentralized network, comprising:
a decentralized computer platform including a processor and a memory;
wherein the decentralized computer platform accesses a distributed ledger;
wherein the decentralized computer platform includes an attestation registry comprising a property registry, a source registry, a value registry, an option registry, and a unit conversion registry;
wherein the property registry defines at least one property including a name, data, a data type, and a source, wherein the at least one property is stored in the property registry;
wherein the source registry governs access to the property stored in the property registry by deploying a smart contract for verifying authorization to access, edit, and/or delete the property;
wherein the value registry includes at least one value associated with the property;
wherein the options registry stores a list of constraint options, wherein the constraint options are enumerations of the at least one value stored in the value registry; and
wherein the unit conversion registry includes a list of one or more smart contracts for converting the data from a first unit format into a second unit format.

11. The system of claim 10, wherein the list of constraint options is automatically updated when the at least one value stored in the value registry is updated.

12. The system of claim 10, wherein the data type is a Boolean data type, an integer data type, a decimal data type, a string data type date and time data type, an object data type, and/or a pointer data type.

13. The system of claim 10, wherein authorization of the smart contract address to access, edit, and/or delete the property is granted based on a role of the smart contract address, an attribute of the smart contract address, a policy of the smart contract address, authorization granted to the smart contract address by a property owner, and/or authorization granted to the smart contract address by a property creator.

14. The system of claim 10, further comprising an oracle, wherein the oracle accesses a third party platform to determine a rate of conversion for converting the data from the first unit format into the second unit format.

15. The system of claim 10, wherein the unit conversion registry receives an input of a plug-in conversion logic, wherein the data is in a first unit format, wherein the second unit format is the desired format of the data, wherein the plug-in conversion logic automatically converts the data from the first unit format into a second unit format.

16. A method of managing trusted data on a decentralized network, comprising:
creating a property registry on a computer platform, wherein the computer platform is implemented on a distributed ledger;
the property registry storing at least one data definition, wherein a property including a name, data, a data type, and a source is defined by the at least one data definition, wherein the property is stored in the property registry;
the property registry using a primary key of the property registry to indicate the location of the name, the data type, and the source within the property registry;
a source registry executing a smart contract to access the property stored in the property registry, wherein the source registry uses a foreign key of the source registry to access the property, wherein the foreign key of the source registry indicates the location of the name, the data type, and the source within the property registry;
adding the property to the source registry, the source registry deploying a smart contract assigning authorization to a smart contract address to enable the smart contract address to access, edit, and/or delete the property;
the source registry executing a smart contract for verifying authorization to access, edit, and/or delete the property;
assigning at least two values to the property and storing the at least two values in a memory of a value registry; and
an options list registry executing a smart contract for enumerating at least one combination of the at least two values stored in the value registry, wherein the enumeration is stored in the options list registry.

17. The method of claim 16, wherein authorization of the smart contract address to access, edit, and/or delete the property is granted based on a role of the smart contract address, an attribute of the smart contract address, a policy of the smart contract address, authorization granted to the smart contract address by a property owner, and/or authorization granted to the smart contract address by a property creator.

18. The method of claim 16, wherein the source registry implements an oracle smart contract for creation and/or identification of at least one complex policy, wherein a policy engine executes a policy engine smart contract to determine compliance of a proposed access, a proposed edit, and/or a proposed deletion of the property with the at least one complex policy.

19. The method of claim 16, wherein a property is created using a class registry, wherein the class registry stores a class template, the class template mapping at least one behavior including an event, an interface, and/or a function, wherein a class template is selected from the class registry to enable the property to inherit the at least one behavior mapped by the class template.

20. The method of claim 16, further comprising at least one developer updating the code of the smart contract for accessing the property stored in the property registry, the smart contract assigning authorization to a smart contract address, and/or the smart contract for verifying authorization.
